(19) United States
(12) Patent Application Publication
(10) Pub. No.: US 2013/0026381 A1
(43) Pub. Date: Jan. 31, 2013

(54) DYNAMIC, REAL TIME ULTRAVIOLET RADIATION INTENSITY MONITOR

(71) Applicants: Gang-Le Huang, Zhubei City (TW); Yeh-Chieh Wang, Hsinchu City (TW); Jiun-Rong Pai, Jhubei City (TW); Hsu-Shui Liu, Pingjhen City (TW); Kuo-Shu Tseng, Taichung City (TW); Chien-Ta Lee, Sanxing Township (TW)

(72) Inventors: Gang-Le Huang, Zhubei City (TW); Yeh-Chieh Wang, Hsinchu City (TW); Jiun-Rong Pai, Jhubei City (TW); Hsu-Shui Liu, Pingjhen City (TW); Kuo-Shu Tseng, Taichung City (TW); Chien-Ta Lee, Sanxing Township (TW)

(73) Assignee: TAIWAN SEMICONDUCTOR MANUFACTURING COMPANY, LTD., Hsin-Chu (TW)

(21) Appl. No.: 13/190,260

(22) Filed: Jul. 25, 2011

(51) Int. Cl. G01J 3/30; G01J 5/08

(52) U.S. Cl. 250/372; 356/213; 356/326

(57) ABSTRACT

An apparatus and method for detecting an intensity of radiation in a process chamber, such as an ultraviolet curing process chamber, is disclosed. An exemplary apparatus includes a process chamber having a radiation source therein, wherein the radiation source is configured to emit radiation within the process chamber; a radiation sensor attached to the process chamber; and an optical fiber coupled with the radiation source and the radiation sensor, wherein the optical fiber is configured to transmit a portion of the emitted radiation to the radiation sensor, and the radiation sensor is configured to detect an intensity of the portion of the emitted radiation via the optical fiber.

### BACKGROUND

Ultraviolet curing uses ultraviolet radiation to heat or cure materials. A specific ultraviolet radiation wavelength and ultraviolet radiation intensity is typically associated with a material layer to ensure adequate curing of the material layer. Failing to maintain the material layer's associated ultraviolet radiation intensity, in other words, a stable ultraviolet radiation intensity, during curing can result in damage to the material layer, such as discoloration, cracking, stickiness, and other issues. A consistent, steady ultraviolet radiation intensity is also desired to ensure a uniform shrink rate in a material layer, such as a spin-on-glass (SOG) material layer. If the shrink rate is non-uniform, a desired thickness of the material layer may not be achieved. Accordingly, various approaches have been implemented to monitor ultraviolet radiation intensity of the ultraviolet radiation used to cure material layers. In an example, a thermometer monitors the ultraviolet radiation intensity by monitoring a substrate temperature (upon which the material layer is disposed) during the ultraviolet curing process. Since the thermometer monitors the substrate temperature, the thermometer is insensitive to the actual ultraviolet radiation intensity, particularly since it is not exposed to the ultraviolet radiation. The thermometer may thus indicate that the ultraviolet radiation intensity has reached an unacceptable level when in reality it has not. In another example, where an ultraviolet curing apparatus uses a microwave source to generate microwave energy for exciting an ultraviolet radiation source that emits the ultraviolet radiation, the ultraviolet radiation intensity is monitored by a radio frequency (RF) detector that is coupled with the microwave energy source. Although existing approaches have been generally adequate for their intended purposes, they have not been entirely satisfactory in all respects.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A and FIG. 1B are block diagrams of a radiation curing apparatus that embodies various aspects of the present disclosure.

FIG. 2 is a flow chart of a method for monitoring a radiation intensity of a radiation source during a curing process that can be implemented by the radiation curing apparatus of FIGS. 1A and 1B according to various aspects of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. For example, if the device in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

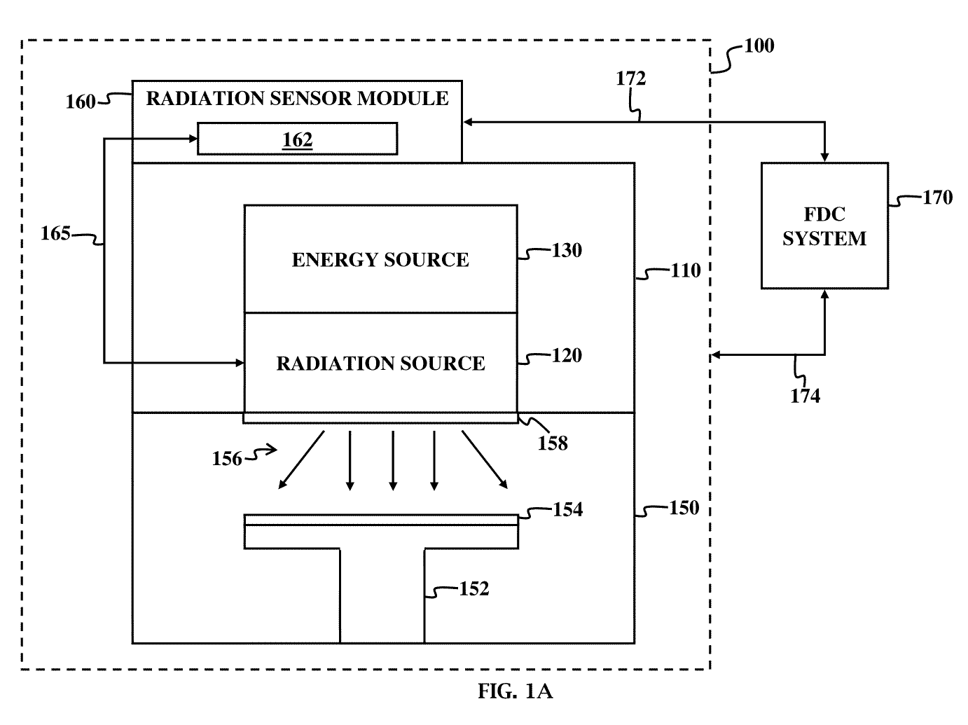

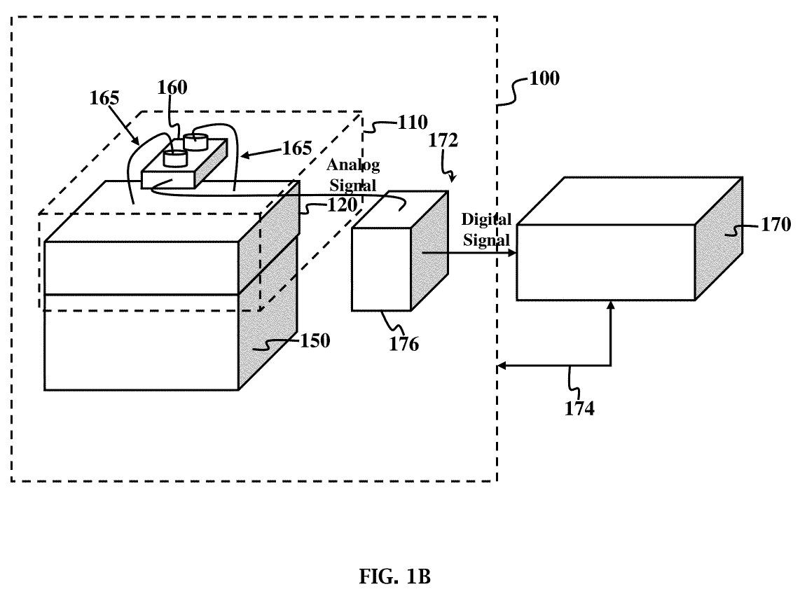

FIG. 1A and FIG. 1B are block diagrams of a radiation curing apparatus 100 that embodies various aspects of the present disclosure. The radiation curing apparatus 100 heats and cures materials, such as a material layer (or film) disposed over a substrate. In the depicted embodiment, as further described below, the radiation curing apparatus 100 is an ultraviolet (UV) radiation curing apparatus. FIGS. 1A and 1B will be collectively described below and are not comprehensive diagrams of the entire radiation curing apparatus 100. Instead, for simplicity and clarity, FIGS. 1A and 1B show only selected portions of the overall apparatus that facilitate an understanding of aspects of the present disclosure. Additional features can be added in the radiation curing apparatus 100, and some of the features described below can be replaced or eliminated for other embodiments of the radiation curing apparatus 100.

The radiation curing apparatus 100 includes a radiation generating portion 110. The radiation generating portion 110 generates radiation that can be used to heat or cure a material layer (film) disposed over a substrate. Any suitable radiation generated to heat or cure a material layer (film) is contemplated, however, for purposes of the following discussion, UV radiation is used to heat or cure the material layer (film). In the depicted embodiment, the radiation generating portion 110 is a UV lamp head. The radiation generating portion 110, such as the UV lamp head, may include dynamic portions configured to move, for example, in a swinging motion, a rotating motion, other suitable motion, or combinations thereof.

The radiation generating portion 110 includes a radiation source 120. In the depicted embodiment, the radiation source 120 is a UV radiation lamp that includes a UV lamp source disposed within a chamber, such as a microwave chamber. The chamber has an oxygen-free atmosphere to ensure that radiation generated by the radiation source 120, such as UV radiation, is not absorbed by the chamber environment. The chamber may be a vacuum chamber. A suitable temperature is maintained within the chamber. For example, a temperature within the chamber is about 25° C. to about 80° C. The UV lamp source housed within the radiation source 120, such as within the chamber, includes one or more UV lamp bulbs. In an example, the UV lamp source is one or more sealed plasma bulbs filled with one or more gases, such as xenon (Xe), mercury (Hg), krypton (Kr), argon (Ar), other suitable gas, or combinations thereof. For example, the UV lamp source may be a mercury lamp, a xenon excimer lamp, an Ar/Kr/Xe excimer lamp, an Xe—HgXe lamp, a vacuum UV lamp, or other suitable UV lamp source. The gases used within the UV lamp source can be selected such that selected UV radiation wavelengths are emitted from the radiation source 120. In the depicted embodiment, the radiation 120 emits radiation having a wavelength of about 10 nm to about 400 nm.

The radiation generating portion 110, a UV lamp head in the depicted embodiment, further includes an energy source 130 coupled with the radiation source 120. The energy source 130 may be coupled to the radiation source 120 via a waveguide, which directs energy produced by the energy source, such as microwave energy, to the radiation source 120. The energy source 130 includes energy sources that excite elements of the radiation source 120, such as the gases of the UV lamp source, so that the radiation source 120 emits radiation. For example, in the depicted embodiment, the energy source 130 includes one or more microwave generators, such as magnetrons, that generate microwave energy (radio frequency (RF) microwave energy) to excite elements of the radiation source 120, such as the gases of the UV lamp source, so that the radiation source 120 generates UV radiation. The energy source 130 may include one or more transformers to energize filaments of the magnetron. Alternatively, the energy source 130 includes radio frequency generators that generate radio frequency energy that can excite elements of the radiation source 120, such as the gases of the UV lamp source, so that the radiation source 120 generates UV radiation.

The radiation generating portion 110 is coupled to a process portion 150. The radiation generating portion 110 and process portion 150 may collectively be referred to as a radiation process chamber, or in the depicted embodiment, a UV process chamber. In the depicted embodiment, the process portion 150 is a process chamber, and more specifically, a curing process chamber. The process portion 150 includes a wafer holder 152. The wafer holder 152 includes a pedestal for supporting a substrate, such as a substrate 154. The substrate 154 may alternatively be referred to as a material layer, or the substrate 154 may include a material layer disposed thereover that will be exposed to the radiation from the radiation source 120. The material layer may be a metal layer, a semiconductor layer, or a dielectric layer. The wafer holder 152 may include a heating mechanism for heating the substrate 154. In an example, a position of the substrate 154 within the process portion 150 is adjusted by a mechanism of the wafer holder 152 that allows the wafer holder 152 to move within the process portion 150. For example, the wafer holder 152 may move vertically, horizontally, or both to position the substrate 154 a particular distance from the radiation source 120. Radiation, such as radiation 156, emitted from the radiation source 120 enters the process portion 150 by passing through a window 158 and exposes the substrate 154. The window 158 is thick enough to maintain vacuum. The window 158 further includes a material, such as quartz, that transmits the radiation 156. It is noted that the radiation source 120 may include an aperture that allows the radiation 156 to travel through to the portion 150, where the aperture prevents (or blocks) microwave energy from traveling into the process portion 150. For example, the aperture may be covered by a fine-meshed metal screen.

A radiation sensor module 160 is coupled to the radiation generating portion 110. Note that the radiation sensor module 160 is disposed outside the radiation process chamber, specifically the UV processing chamber. More specifically, the radiation sensor module 160 is disposed outside (put another way, not within) the radiation generating portion 110 and the process portion 150. In an example, the radiation sensor module 160 is attached to the radiation generating portion 110. The radiation sensor module 160 may be attached to a top of the radiation generation portion 110 or a side of the radiation generating portion 110. In an example, the radiation sensor module 160 is attached to a dynamic portion of the radiation generating portion 110, such as a portion of the radiation generating portion 110 configured to move in a swinging motion. The radiation sensor module 160 may thus move along with the radiation generating portion 110. Alternatively, the radiation sensor module 160 is attached to other portions of the radiation curing apparatus 100, such as to the process portion 150.

The radiation sensor module 160 detects and converts radiation emitted from the radiation source 120 into electronic signals. For example, the radiation sensor module 160 measures a physical quantity of radiation (such as an intensity of the radiation) emitted from the radiation source 120 and translates such physical quantity into a form readable by an instrument, such as a fault detection and classification system. The radiation sensor module 160 can thus measure changes, such as intensity variations, in radiation emitted from the radiation source 120. In the depicted embodiment, the radiation sensor module 160 includes a radiation sensor, such as an optical sensor 162. The optical sensor 162 detects radiation emitted from the radiation source 120 and converts the detected radiation into electronic signals that indicate characteristics of the detected radiation, such as the intensity of the detected radiation. In the depicted embodiment, the optical sensor 162 detects and measures radiation having a wavelength of about 10 nm to about 400 nm. Examples of the optical sensor 162 include a photodiode sensor, an optical emission spectrometer (OES), an optical fiber thermometer (OFT), other suitable optical sensors, or combinations thereof. The radiation sensor module 160 may include more than one optical sensor 162. For example, where the radiation source 120 is a UV lamp, as in the depicted embodiment, the number of optical sensors 162 that the radiation sensor module 160 includes correlates with a number of UV lamp sources that the radiation source 120 includes—if the UV lamp includes two lamp sources, the radiation sensor module 160 includes two optical sensors 162, and so on, where each optical sensor 162 monitors an intensity of emitted radiation from its associated lamp source.

One or more optical fibers 165 are coupled between the radiation sensor module 160 and the radiation generating portion 110, specifically, the radiation source 120 and the optical sensor 162. The number of optical fibers 165 correlates with the number of optical sensors 162 included in the radiation sensor module 160. The optical fiber 165 transmits radiation, such as UV radiation, from the radiation source 120 to the optical sensor 162 so that the radiation sensor module 160 can detect an intensity of the radiation emitted from the radiation source 120. The optical fiber 165 transmits radiation of any suitable wavelength. In the depicted embodiment, the optical fiber 165 transmits radiation having a wavelength of about 10 nm to about 400 nm. Various characteristics of the optical fiber 165 may be selected to achieve transmission of various radiation wavelengths. In an example, the optical fiber 165 has a numerical aperture less than about 0.5. In an example, the optical fiber 165 yields an acceptance angle greater than or equal to about 20.0° in air. Other numerical apertures, acceptance angles, and optical fiber characteristics are contemplated by the present disclosure.

A fault detection and classification (FDC) system 170 is coupled to the radiation sensor module 160 and the radiation curing apparatus 100. The FDC system 170 communicates with the radiation sensor module 160 via line 172, and the FDC system 170 communicates with the radiation curing apparatus 100, including the radiation source 120 and the energy source 130, via line 174. A signal interface 176 receives, from the radiation sensor module 160, electrical signals indicative of an intensity of the radiation emitted from radiation source 120 (the electrical signals may be referred as optical sensor signals) and outputs the electrical signals in a form that can be read and interpreted by the FDC system 170. In an example, the radiation sensor module 160 provides electrical signals, such as analog signals, that indicate an intensity of the radiation emitted from radiation source 120 to the signal interface 176, which converts the analog signals to digital signals, which are provided to, read by, and interpreted by the FDC system 170. This may be the case where the optical sensor 162 is a UV diode, and the signal interface 176 may be an analog/digital converter. In another example, the radiation sensor module 160 provides electrical signals, such as digital signals, that indicate an intensity of the radiation emitted from radiation source 120 to the signal interface 176, which provides the digital signals to the FDC system 170, so that the FDC system 170 can read and interpret such signals. This may be the case where the optical sensor 162 is an OES or OFT.

The FDC system 170 establishes a baseline of tool operation, such as a baseline of operation for the radiation curing apparatus 100, and compares current operation of the radiation curing apparatus 100 with the baseline operation of the radiation curing apparatus 100 to detect faults as well as classify or determine a root cause of any variances between the baseline and current operation. The techniques used for FDC include statistical process control (SPC), principle component analysis (PCA), partial least squares (PLS), other suitable techniques, and combinations thereof. The FDC system 170 can include applications for managing alarm/fault conditions. When an alarm and/or fault condition is detected, the FDC application can send a message to the radiation curing apparatus 100. For example, in the depicted embodiment, the FDC system 170 communicates with the radiation curing apparatus 100, specifically the radiation sensor module 160 via line 172 to monitor an intensity of emitted radiation from the radiation source 120 during processing of a material layer, for example, during curing of the material layer. Specifically, the optical sensor 162 feeds electrical signals related to the intensity of the radiation emitted by radiation source 120 to the FDC system 170 via line 172. The FDC system 170 then monitors the intensity signal to determine whether the emitted radiation intensity is at a suitable level. In an example, the FDC system 170 monitors whether the emitted radiation intensity is within a specified range of intensities. In another example, the FDC system 170 monitors whether the emitted radiation intensity has risen above a specified threshold, or fallen below a specified threshold. If the FDC system 170 determines that the emitted radiation intensity is not at a suitable level, the FDC system 170 communicates with the radiation curing apparatus 100 via line 174 to adjust processing conditions. For example, the FDC system 170 may communicate with the energy source 130 of the radiation curing apparatus 100 so that the energy source 130 adjusts its power output, thereby adjusting the power received by the radiation source 120 to produce emitted radiation, thus modifying an intensity of the emitted radiation. Accordingly, real-time and accurate monitoring of a process that uses radiation, such as a curing process that uses radiation, is achieved.

As noted above, the radiation sensor module 160 is disposed outside the radiation process chamber, specifically the UV processing chamber, and the optical fiber 165 transmits radiation emitted from the radiation source 120 to the radiation sensor module 160, specifically the optical sensor 162, so that characteristics of the emitted radiation by the radiation source 120, such as the intensity of the radiation, is monitored. More specifically, the radiation sensor module 160 is disposed outside (put another way, not within) the radiation generating portion 110 and the process portion 150. By placing the radiation sensor module 160 outside the radiation process chamber, and particularly outside the radiation generating portion 110, radiation emitted from the radiation source 120 is monitored without the emitted radiation from the radiation source or energy produced by the energy source 130 interfering with the instruments that monitor the emitted radiation (here, the radiation sensor module 160). For example, the radiation sensor module 160 is not affected by high temperatures and microwave energy within the chamber of the radiation source 120, yet the radiation sensor module 160 can monitor the radiation emitted from the radiation source 120 via the optical fiber 165. The radiation sensor module 160 can thus precisely indicate any decay or issues with the emitted radiation from the radiation source 120. Further, as noted above, the radiation sensor module 160 may be disposed on a dynamic portion of the radiation generating portion 110, such that the radiation sensor module 160 moves along with the dynamic portion of the radiation generating portion 110. Placing the radiation sensor module 160 on a dynamic portion of the radiation generating portion 110 provides stable, consistent detection of the radiation emitted from the radiation source 120 since motion of the radiation sensor module 160 is synchronized with motion of the radiation generating portion 110. The synchronized motion can eliminate noise in the radiation intensity signals that can arise from unsynchronized motion. Different embodiments may have different advantages, and no particular advantage is necessarily required of any embodiment.

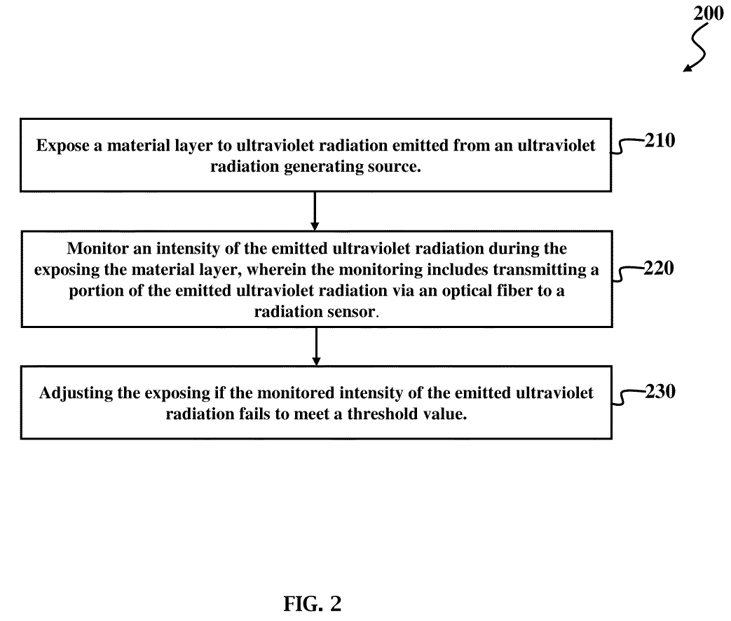

FIG. 2 is a flow chart of a method 200 for monitoring a radiation intensity of a radiation source during a curing process that can be implemented by the radiation curing apparatus of FIGS. 1A and 1B according to various aspects of the present disclosure. At block 210, a material layer is exposed to ultraviolet radiation emitted from an ultraviolet radiation generating source. For example, referring to the radiation curing apparatus 100 above, the source 120 of the radiation generating portion 110 emits radiation 156, thereby exposing the substrate 154 within process portion 150 to radiation 156. At block 220, an intensity of the emitted ultraviolet radiation is monitored during the exposing the material layer. Monitoring includes transmitting a portion of the emitted ultraviolet radiation via an optical fiber to a radiation sensor. For example, referring to the radiation curing apparatus 100 above, a portion of the radiation 156 is transmitted to the optical sensor 162 of the radiation sensor module 160 via optical fiber 165. The optical sensor 162 detects the transmitted radiation and converts the transmitted radiation into an electrical signal that indicates characteristics of the transmitted, emitted radiation, such as an intensity of the radiation. Such information can be communicated to the FDC system 170. At block 230, if the monitored intensity of the emitted ultraviolet radiation fails to meet a threshold value, the exposing is adjusted. For example, referring to the radiation curing apparatus 100 above, the FDC system 170 continuously monitors the measured intensity of the radiation emitted from the radiation source 120, and if the measured intensity falls above or below a threshold value, the FDC system 170 communicates with the radiation curing apparatus 100 to adjust the process, such as the exposing, being carried out by the radiation curing apparatus 100. In an example, a power output of the energy source 130 is adjusted, thereby adjusting the power received by the radiation source 120, such that an intensity of the emitted radiation from the radiation source 120 is adjusted. Additional steps can be provided before, during, and after the method 200, and some of the steps described can be replaced, eliminated, or moved around for additional embodiments of the method 200.

The present embodiments can take the form of an entirely hardware embodiment, an entirely software embodiment, or an embodiment containing both hardware and software elements. Furthermore, embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium can be any apparatus that can contain, store, communicate, propagate, or transport the program for use by or in connection with the instruction execution system, apparatus, or device. The medium can be an electronic, magnetic, optical, electromagnetic, infrared, a semiconductor system (or apparatus or device), or a propagation medium.

The present disclosure provides for many different embodiments. In an example, an apparatus includes a process chamber having a radiation source therein, wherein the radiation source is configured to emit radiation within the process chamber; a radiation sensor attached to the process chamber; and an optical fiber coupled with the radiation source and the radiation sensor, wherein the optical fiber is configured to transmit a portion of the emitted radiation to the radiation sensor, and the radiation sensor is configured to detect an intensity of the portion of the emitted radiation via the optical fiber. The radiation may be ultraviolet radiation. The radiation may have a wavelength of about 10 nm to about 400 nm. The process chamber may be a ultraviolet curing chamber. The radiation sensor may be attached to a dynamic portion of the process chamber, which in an example, is configured for a swinging motion. The radiation sensor is an optical sensor, such as a photodiode, an optical emission spectrometer, or an optical fiber thermometer. The apparatus further includes a fault detection and classification (FDC) system coupled to the radiation sensor and the process chamber. The radiation sensor is configured to feed the intensity of the emitted radiation in real-time to the FDC system.

In another example, an apparatus includes an ultraviolet radiation process chamber having a ultraviolet radiation source therein; an ultraviolet radiation sensor module disposed outside the ultraviolet radiation process chamber; and an optical fiber between the ultraviolet radiation sensor module and the ultraviolet radiation process chamber, such that the optical fiber transmits ultraviolet radiation emitted from the ultraviolet radiation source to the ultraviolet radiation sensor module, such that the ultraviolet radiation sensor module monitors an intensity of the emitted ultraviolet radiation. The ultraviolet radiation sensor includes an optical sensor, wherein the optical sensor is coupled with the optical fiber. The optical sensor is one of a photodiode, an optical emission spectrometer, and an optical fiber thermometer. The ultraviolet radiation sensor may be attached to the ultraviolet radiation process chamber. The ultraviolet radiation sensor may be attached to a dynamic portion of the ultraviolet radiation process chamber. The ultraviolet radiation may have a wavelength of about 10 nm to about 400 nm.

In yet another example, a method includes exposing a material layer to ultraviolet radiation emitted from an ultraviolet radiation generating source; monitoring an intensity of the emitted ultraviolet radiation during the exposing the material layer, wherein the monitoring includes transmitting a portion of the emitted ultraviolet radiation via an optical fiber to a radiation sensor; and adjusting the exposing if the monitored intensity of the emitted ultraviolet radiation fails to meet a threshold value. Monitoring the intensity may include measuring, by the radiation sensor, the intensity of the portion of the emitted ultraviolet radiation. Monitoring the intensity may further include transmitting the measured intensity to a fault detection and classification (FDC) system, wherein the FDC system determines if the monitored intensity of the emitted ultraviolet radiation fails to meet the threshold value. Adjusting the exposing if the monitored intensity of the emitted ultraviolet radiation fails to meet a threshold value includes one of: adjusting the exposing if the monitored intensity of the emitted ultraviolet radiation is greater than a threshold intensity; adjusting the exposing if the monitored intensity of the emitted ultraviolet radiation is lower than a threshold intensity; and adjusting the exposing if the monitored intensity of the emitted ultraviolet radiation falls outside a threshold range.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An apparatus comprising:
a process chamber having a radiation source therein, wherein the radiation source is configured to emit radiation within the process chamber;
a radiation sensor attached to the process chamber; and
an optical fiber coupled with the radiation source and the radiation sensor, wherein the optical fiber is configured to transmit a portion of the emitted radiation to the radiation sensor, and the radiation sensor is configured to detect an intensity of the portion of the emitted radiation.

2. The apparatus of claim 1 wherein the radiation is ultraviolet radiation.

3. The apparatus of claim 1 wherein the radiation has a wavelength of about 10 nm to about 400 nm.

4. The apparatus of claim 1 wherein the process chamber is a ultraviolet curing chamber.

5. The apparatus of claim 1 wherein the radiation sensor is attached to a dynamic portion of the process chamber.

6. The apparatus of claim 5 wherein the dynamic portion of the process chamber is configured for a swinging motion.

7. The apparatus of claim 1 wherein the radiation sensor is an optical sensor.

8. The apparatus of claim 7 wherein the optical sensor is one of a photodiode, an optical emission spectrometer, and an optical fiber thermometer.

9. The apparatus of claim 1 further comprising a fault detection and classification (FDC) system coupled to the radiation sensor and the process chamber.

10. The apparatus of claim 9 wherein the radiation sensor is configured to feed the intensity of the emitted radiation in real-time to the FDC system.

11. An apparatus comprising:
an ultraviolet radiation process chamber having a ultraviolet radiation source therein;
an ultraviolet radiation sensor module disposed outside the ultraviolet radiation process chamber; and
an optical fiber coupled between the ultraviolet radiation sensor module and the ultraviolet radiation process chamber, such that the optical fiber is configured to transmit ultraviolet radiation emitted from the ultraviolet radiation source to the ultraviolet radiation sensor module, wherein the ultraviolet radiation sensor module is configured to monitor an intensity of the emitted ultraviolet radiation.

12. The apparatus of claim 11 wherein the ultraviolet radiation sensor includes an optical sensor, wherein the optical sensor is coupled to the optical fiber.

13. The apparatus of claim 12 wherein the optical sensor is one of a photodiode, an optical emission spectrometer, and an optical fiber thermometer.

14. The apparatus of claim 10 wherein the ultraviolet radiation sensor is attached to the ultraviolet radiation process chamber.

15. The apparatus of claim 14 wherein the ultraviolet radiation sensor is attached to a dynamic portion of the ultraviolet radiation process chamber.

16. The apparatus of claim 10 wherein the ultraviolet radiation has a wavelength of about 10 nm to about 400 nm.

17. A method comprising:
exposing a material layer to ultraviolet radiation emitted from an ultraviolet radiation generating source;
monitoring an intensity of the emitted ultraviolet radiation during the exposing the material layer, wherein the monitoring includes transmitting a portion of the emitted ultraviolet radiation via an optical fiber to a radiation sensor; and
adjusting the exposing if the monitored intensity of the emitted ultraviolet radiation fails to meet a threshold value.

18. The method of claim 17 wherein the monitoring the intensity of the emitted ultraviolet radiation during the exposing the material layer includes measuring, by the radiation sensor, the intensity of the portion of the emitted ultraviolet radiation.

19. The method of claim 18 wherein the monitoring the intensity of the emitted ultraviolet radiation during the exposing the material layer includes transmitting the measured intensity to a fault detection and classification (FDC) system, wherein the FDC system determines if the monitored intensity of the emitted ultraviolet radiation fails to meet the threshold value.

20. The method of claim 17 wherein the adjusting the exposing if the monitored intensity of the emitted ultraviolet radiation fails to meet a threshold value includes one of:
adjusting the exposing if the monitored intensity of the emitted ultraviolet radiation is greater than a threshold intensity;
adjusting the exposing if the monitored intensity of the emitted ultraviolet radiation is lower than a threshold intensity; and
adjusting the exposing if the monitored intensity of the emitted ultraviolet radiation falls outside a threshold range.
